(19) United States
(12) Patent Application Publication
(10) Pub. No.: US 2015/0273510 A1
(43) Pub. Date: Oct. 1, 2015

(54) METHOD AND APPARATUS FOR AEROSOL DIRECT WRITE PRINTING

(71) Applicant: NDSU RESEARCH FOUNDATION, Fargo, ND (US)

(72) Inventor: Justin Hoey, Fargo, ND (US)

(73) Assignee: NDSU RESEARCH FOUNDATION, Fargo, ND (US)

(21) Appl. No.: 14/202,801

(22) Filed: Mar. 10, 2014

Related U.S. Application Data
(63) Continuation-in-part of application No. 12/192,315, filed on Aug. 15, 2008, now abandoned.
Application No. 12/192,315 is a continuation-in-part of application No. PCT/US2008/073257, filed on Aug. 15, 2008.
(60) Provisional application No. 61/786,298, filed on Mar. 14, 2013.
(60) Provisional application No. 60/956,493, filed on Aug. 17, 2007.
(60) Provisional application No. 60/956,493, filed on Aug. 17, 2007.

(51) Int. Cl. B05B 17/06; B05D 1/02; B05B 1/30; B05B 1/28; B05B 1/14

(52) U.S. Cl. CPC B05B 17/0607; B05B 1/28; B05B 1/14; B05B 1/30; B05D 1/02

(57) ABSTRACT

An aerosol deposition system that uses a liquid ink, fed directly to an ultrasonic source at or near a nozzle to form an aerosolized ink, which may be transported via a carrier gas to a sheath gas insertion location is presented. The sheath gas may direct or focus the atomized ink through a nozzle. Alternatively, a deposition head may be adapted to the ultrasonic source so that aerosolization of the ink occurs inside the deposition head, where the sheath gas flows around the ultrasonic source, transporting the aerosolized ink through a nozzle and toward a substrate ˜2 mm distant. The substrate may be translated to form features of controlled shape such as lines with widths from ≦30 μm to 100 μm. Variations of this system may yield systems where a carrier gas is unnecessary, and all aerosolized ink is transported via the sheath gas.

### CROSS-REFERENCE TO RELATED APPLICATIONS

This application claims the benefit of U.S. provisional patent application Ser. No. 61/786,298 filed on Mar. 14, 2013, incorporated herein by reference in its entirety. This application is a continuation-in-part of U.S. patent application Ser. No. 12/192,315 filed on Aug. 15, 2008, incorporated herein by reference in its entirety, which claims benefit of U.S. provisional patent application Ser. No. 60/956,493 filed on Aug. 17, 2007, incorporated herein by reference in its entirety. This application is a continuation-in-part of PCT international application number PCT/US2008/073257 filed on Aug. 15, 2008, incorporated herein by reference in its entirety, which claims the benefit of U.S. provisional patent application Ser. No. 60/956,493 filed on Aug. 17, 2007, incorporated herein by reference in its entirety. Priority is claimed to each of the foregoing applications.

This application is related to US patent application publication number 2009/0053507 A1 published on Feb. 26, 2009, incorporated herein by reference in its entirety.

This application is related to PCT International Publication No. WO 2009/026126 on Feb. 26, 2009, incorporated herein by reference in its entirety.

### STATEMENT REGARDING FEDERALLY SPONSORED RESEARCH OR DEVELOPMENT

This invention was made with Government support under H94003-07-2-0701, H94003-08-2-0801, and H94003-08-2-0805 awarded by the Department of Defense/Defense Microelectronics Activity (DOD/DMEA). The Government has certain rights in the invention.

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to direct write printing, and more particularly to direct write printing of line widths ≦100 μm, ≦50 μm, ≦25 μm, ≦12 μm, and ≦6 μm.

2. Description of Related Art

Aerosols have long been used to deposit materials for films and for the printing of fine features. Three common methods of atomization exist: pneumatic, ultrasonic, and high velocity jet. These methods find use in tools such as automotive paint sprayers, coating systems such as those used by Sono-Tek®, and in airless paint sprayers.

Ultrasonic atomization is used in the generation of small droplets of water in humidification. However, in water humidification, the flow rate of water exceeds the flow rates used in small-scale direct write printing by multiple orders of magnitude.

### BRIEF SUMMARY OF THE INVENTION

In one aspect of the invention, an aerosol deposition system uses a liquid ink fed directly to an ultrasonic source at or near a nozzle to form an aerosolized ink, which may be transported via a carrier gas to a sheath gas insertion location. The sheath gas may direct or focus the atomized ink through a nozzle.

Alternatively, a deposition head may be adapted to an ultrasonic source so that aerosolization of the ink occurs inside the deposition head, where the sheath gas flows around the ultrasonic source, entraining and transporting the aerosolized ink through a nozzle and toward a substrate ˜2 mm away. The substrate may be translated to form features of controlled shape such as lines with widths from ≦10 μm to 100 μm. Variations of this system may yield systems where a carrier gas is unnecessary, and all aerosolized ink is entrained and transported via the sheath gas.

Once an ink is aerosolized, it may be transported by a carrier gas to a location of sheath gas insertion.

The nozzles used in the direct print system may be commercially available convergently focusing nozzles, convergent barrel nozzles, or convergent-divergent-convergent nozzles. An annular coaxial flow of sheath gas may be used to collimate and focus aerosolized ink through a nozzle with an inner diameter near 100 μm and a length of 19 mm.

In another example, a deposition head may be directly attached to an ultrasonic source so that aerosolization of the ink occurs within the deposition head. In this case, sheath gas flows around the ultrasonic source terminus, further assisting in focusing of the aerosolized ink through a nozzle of dimensions similar to those described before.

The focused aerosolized ink, upon leaving the nozzle, is directed towards a substrate with substrate to nozzle distance of about 2 mm. The substrate may be translated to form features of controlled shape such as lines with widths from about 10 μm to 100 μm.

In another aspect of the invention, the system may be so designed as to preclude the use of carrier gas, such that only the sheath gas may be necessary for operation.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a partial cross sectional view of a prior art ultrasonic source that uses a sheath gas for aerosolized ink generation.

FIG. 2 is a partial cross sectional view of a prior art ultrasonic source, where an ink is introduced along with a concentrically located carrier gas.

FIG. 3A is a partial cross sectional view of a prior art ultrasonic source flowing aerosolized ink through a coupling shroud, thence into a prior art sheath gas shroud, and finally into a converging nozzle.

FIG. 3B is a system schematic of the aerosolized ink printer of FIG. 3A.

FIG. 4 is a partial cross sectional view of a prior art ultrasonic source flowing aerosolized ink through a coupling shroud, thence into a prior art sheath gas shroud, and finally into a collimated-aerosol-beam nozzle for direct write printing.

FIG. 5A is a partial cross sectional view of a prior art ultrasonic source flowing aerosolized ink through an integrated sheath coupling shroud into a converging nozzle for direct write printing.

FIG. 5B is a system photograph of the aerosolized ink printer of FIG. 5A with the converging nozzle removed.

FIG. 6 is a partial cross sectional view of a prior art ultrasonic source flowing aerosolized ink through an integrated sheath coupling shroud into a collimated-aerosol-beam nozzle for direct write printing.

FIG. 7A is a first micrograph of lines direct printed with a 200 μm nozzle using Ag ink, resulting in a line width of approximately 100 μm.

FIG. 7B is a second micrograph of a different region of lines direct printed with a 200 μm nozzle using Ag ink, resulting in a line width of approximately 100 μm.

FIG. 8A is a first micrograph of lines direct printed with a 100 μm collimated-aerosol-beam nozzle using Ag ink, resulting in a line width of approximately 40-60 μm.

FIG. 8B is a second micrograph of a different region of direct printed with a 100 μm collimated-aerosol-beam nozzle using Ag ink, resulting in a line width of approximately 40-60 μm.

FIG. 8C is a third micrograph of a different region of direct printed with a 100 μm collimated-aerosol-beam nozzle using Ag ink, resulting in a line width of approximately 30 μm.

FIG. 9A is a micrograph of a line printed with a 300 μm converging nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

FIG. 9B is a micrograph of a line printed with a 200 μm converging nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

FIG. 9C is a micrograph of a line printed with a 150 μm converging nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

FIG. 9D is a micrograph of a line printed with a 100 μm converging nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

FIG. 9E is a micrograph of a line printed with a 100 μm collimated-aerosol-beam nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

FIG. 10 is a graph of the height of a cross section of the trace of FIG. 9E, indicating that the edges of the printed line are thicker than the center, likely due to readily correctable ink surface tension effects.

### DETAILED DESCRIPTION OF THE INVENTION

### Definitions

Aerosol means a suspension of either solid particles or liquid droplets in a gas.

Aerosolize means to make an aerosol of a liquid in a gas. The liquid may or may not suspend solids, or may be completely liquid in nature.

### BACKGROUND

Aerosols occur naturally, but are also produced on demand for use in industrial processes. In pneumatic atomization, a high velocity gas flow is used to turbulently shear an impinging stream of liquid, and then carry the droplets produced to their final destination.

Spraying Systems Co. offers many nozzles of the pneumatic atomization type, including the ¼ J nozzle that can produce water droplets in the 10 to 50 micron range for use in humidification systems. Unfortunately, the volume flow rate of liquid and gas needed to operate most pneumatic nozzle systems typically range from 25, 100, 250 mL/min of liquid, and from 5, 10, 25 L/min gas, which is higher than needed for direct write printing applications. Ultrasonic atomization has been able to overcome this very high relative volume flow rate obstacle by employing ultrasonic energy to break droplets apart rather than shearing the liquid with the gas at high velocity.

Ultrasonic atomization relies on ultrasonic pressure waves to break apart an ink film, thereby forming droplets. Ultrasonic atomization at this point in time appears to be the most conducive to direct write printing applications because aerosol formation appears relatively independent of either sheath gas or ink flow rates.

An important issue in direct write printing is the ability to start and stop aerosolization. With ultrasonic aerosolization, the ultrasonic drive energy may be turned on or off. Alternatively, the flow of the liquid ink supplied to the ultrasonic source may be stopped, also resulting in the cessation of aerosolization of the ink.

Ultrasonic atomization has also proven itself reliable enough to be used in high precision instrumentation such as Inductively Coupled Plasma-Atomic Emission Spectroscopy (ICP-AES). In this system, an ultrasonic atomizer is used to create an aerosol which can then feed the sample into the remainder of the apparatus for further processing. The creation of aerosols via micro-electro-mechanical-systems (MEMS)-based piezoelectric systems has also been proven feasible.

Unfortunately, many of the MEMS-based systems rely on micro nozzles that potentially become clogged leading to decreased performance.

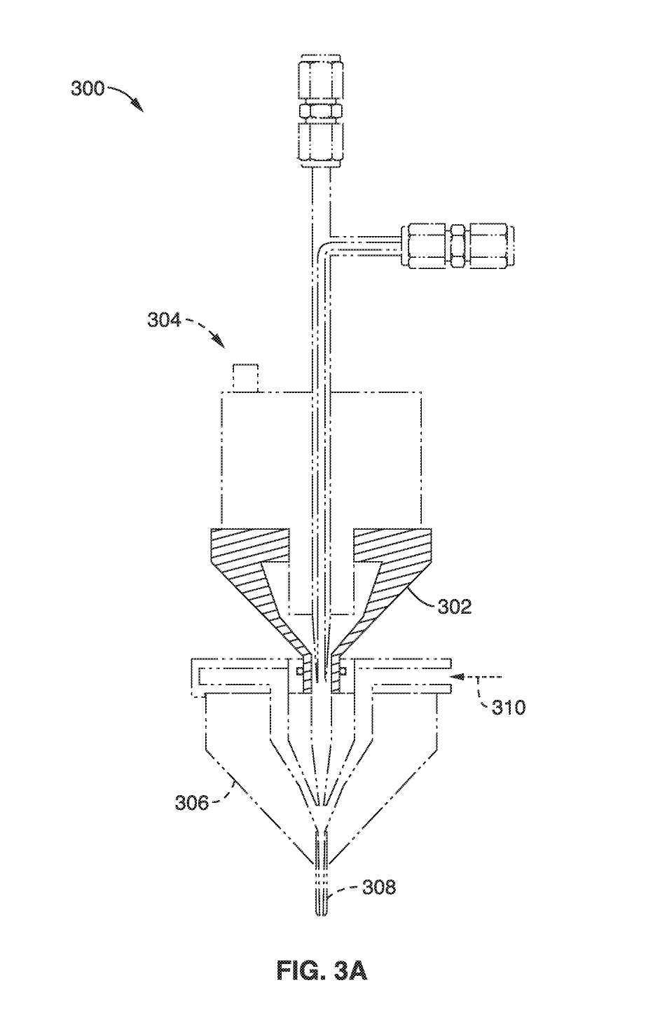

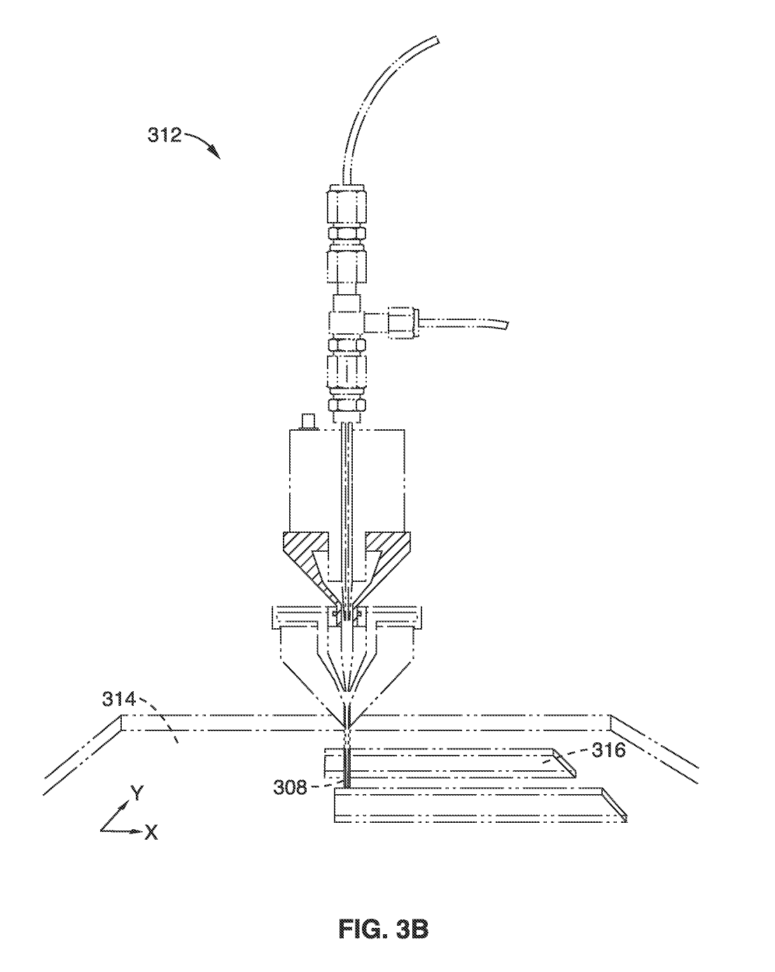

Nozzles that have been used for direct write printing include: 1) a converging focusing nozzle, 2) a convergent-divergent-convergent nozzle, and 3) a convergent barrel nozzle, described in FIG. 3 of: J. M. Hoey, A. Lutfurakhmanov, M. J. Robinson, O. F. Swenson, and D. L. Schulz, “Advances in aerosol direct-write technology for fine line applications,” presented at the ASME International Mechanical Engineering Congress and Exposition, Houston, Tex., USA, 2012, hereby incorporated by reference in its entirety.

Inks usable in direct write printing include, without limitation, organometallic inks, solution processable materials, as well as inks made up of metallic and non-metallic nanoparticles suspended in solution, all of which are currently being used in the electronics and renewable energy sectors. The collimated aerosol beam direct write (CAB-DW) nozzle system has already demonstrated capabilities of producing lines as narrow as 5-10 μm.

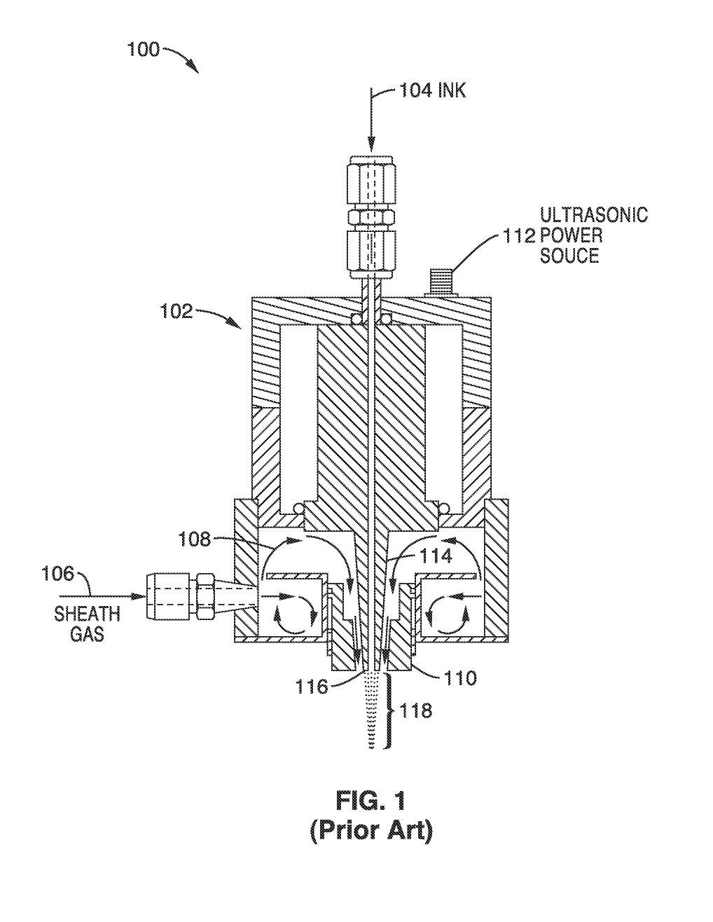

Refer now to FIG. 1, which is a partial cross sectional view 100 of a prior art ultrasonic source 102 that uses a sheath gas for aerosolized ink generation. Here, an ink 104 is supplied to the ultrasonic source 102 via direct pressure injection. The ink 104 is typically a suspension of material to be atomized by the ultrasonic source 102. A sheath gas 106 is introduced into the ultrasonic source 102, which flows through a plenum 108 and ultimately exits the ultrasonic source 102 at an exit region 110. An ultrasonic power source 112 supplies power to a piezoelectric ultrasonic sound generator 114, here an axisymmetric ultrasonic horn. At a distal end of the ultrasonic horn 116, the ink 104 is broken up into aerosolized ink 118 droplets that continue to exit the ultrasonic source 102, propelled by the sheath gas 106 passing out of the exit region 110.

In one embodiment of the ultrasonic source 102, the ultrasonic horn 116 atomizer operates at about 120 kHz and produces an aerosolized ink 118 with a droplet diameter of around 18 μm.

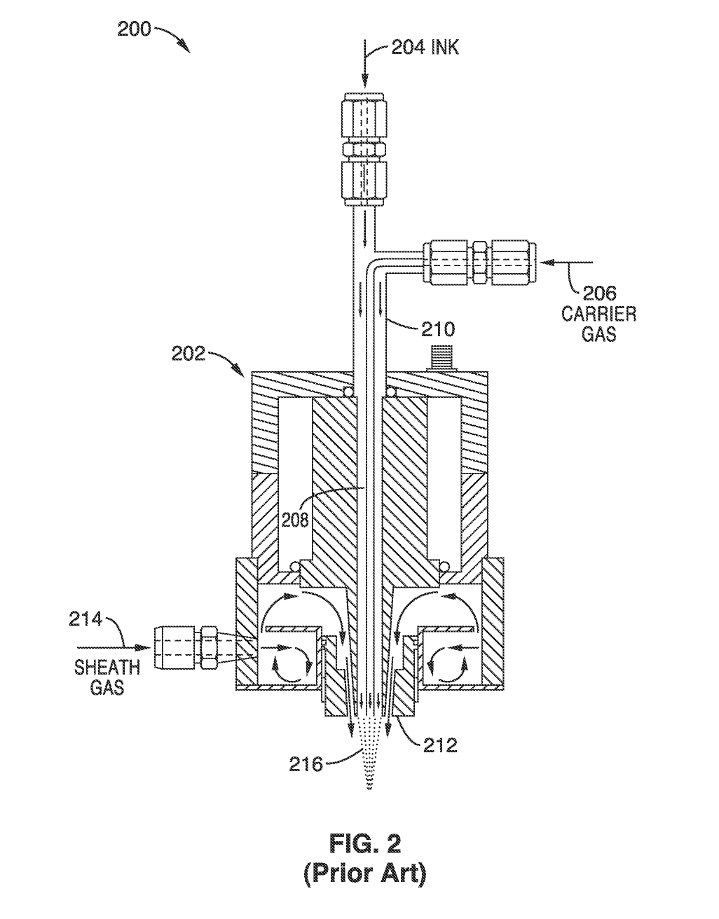

Refer now to FIG. 2, which is a partial cross sectional view 200 of a prior art ultrasonic source 202, where an ink 204 is introduced along with a concentrically located carrier gas 206. In this example, the carrier gas 206 is fed through a carrier gas tube 208 within an ink feed tube 210, ultimately exiting the ultrasonic source 202 terminus 212. A sheath gas 214 is supplied along with the carrier gas 206 to propel and focus aerosolized ink 216 particles from the ultrasonic source 202 terminus 212.

In an alternate embodiment, ink is fed through the carrier gas tube 208, and carrier gas is fed through the ink feed tube 210, both the ink and the carrier gasses having the same functions as previously described.

Refer now to FIG. 3A, which is a partial cross sectional view 300 of a coupling shroud 302 disposed between and connecting a prior art ultrasonic source 304. The flowing aerosolized ink (not shown here) travels from the ultrasonic source 304, then through the coupling shroud 302, and thence into a prior art sheath gas shroud 306, and finally into a converging nozzle 308. Here, the coupling shroud 302 adapts the prior art ultrasonic source 304, typically used for atomization of water in humidification systems to the prior art sheath gas shroud 306.

Typically, one would not be inclined to use the ultrasonic source 304 capable of aerosolizing orders of magnitude flow rates in conjunction with the sheath gas shroud 306 due to the very limited flow rates possible in the nozzle 308. Additionally, a sheath gas 310 is introduced into the sheath gas shroud 306, thereby surrounding and transporting aerosolized particles created by the ultrasonic source 304.

The ultrasonic source 304 was furnished by Sono-Tek, and the coupling shroud was designed by North Dakota State University (NDSU). The sheath gas shroud 306 was a deposition head from Optomec (presently termed the Aerosol Jet system).

Refer now to FIG. 3B, which is a system schematic 312 of the aerosolized ink printer 300 of FIG. 3A. Here, a platen 314 is capable of XY translations of a substrate 316 relative to the stationary converging nozzle 308. Standoff from the converging nozzle 308 to the substrate 316 is typically maintained at around 2 mm.

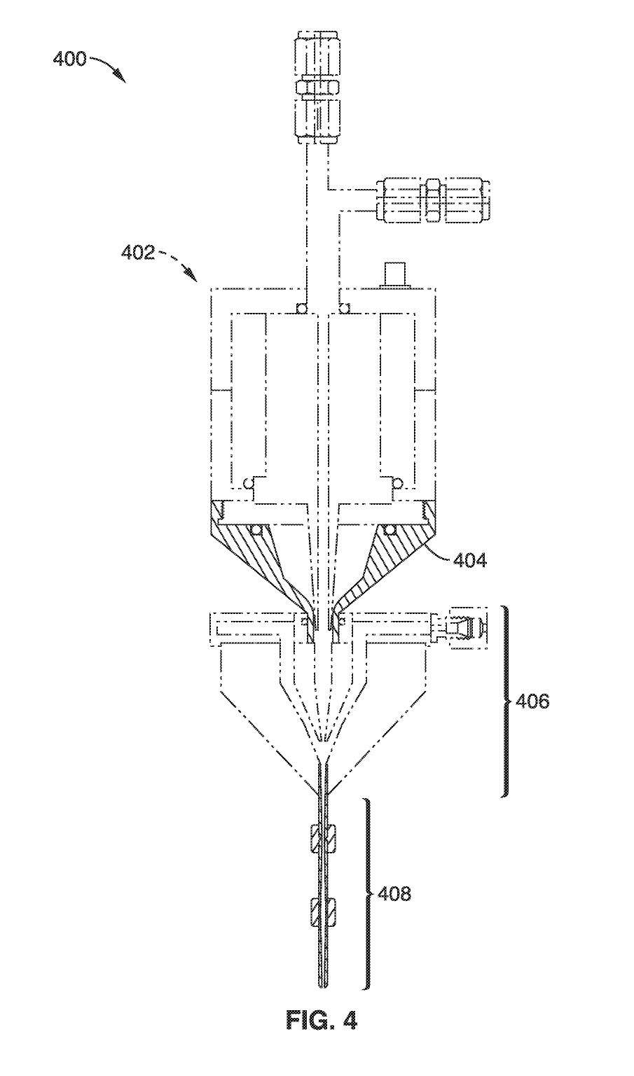

Refer now to FIG. 4, which is a partial cross sectional view 400 of a prior art ultrasonic source 402 flowing aerosolized ink through a coupling shroud 404, thence into a prior art sheath gas shroud 406, and finally into a collimated-aerosol-beam nozzle 408 for direct write printing.

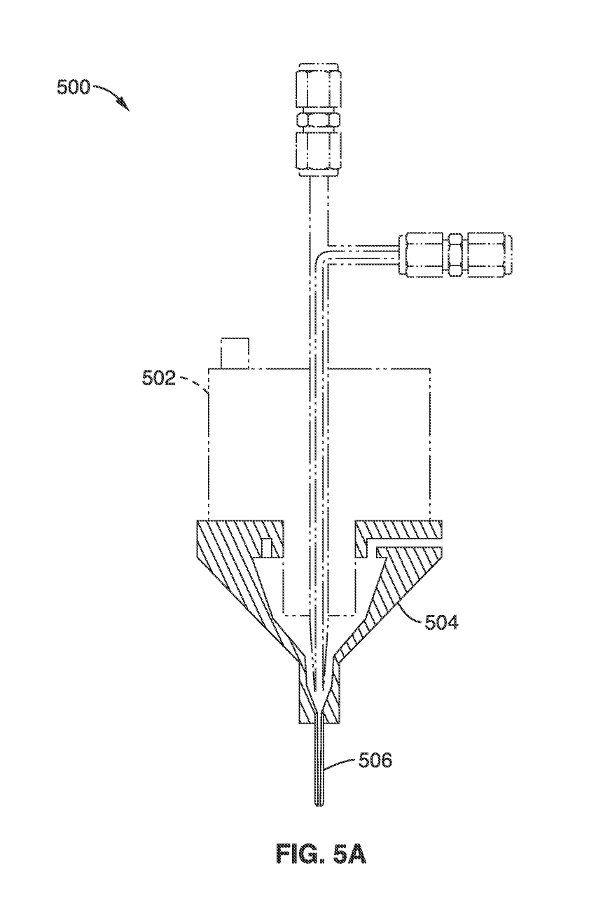

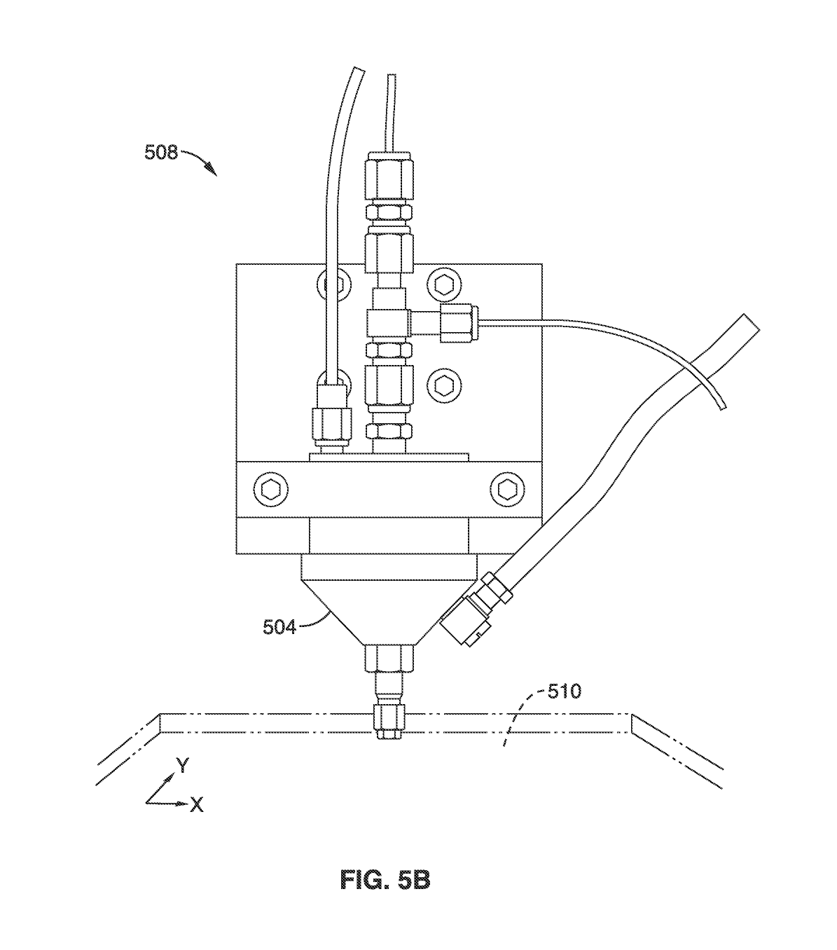

Refer now to FIG. 5A, which is a partial cross sectional view 500 of a prior art ultrasonic source 502 flowing aerosolized ink through an integrated sheath coupling shroud 504 into a converging nozzle 506 for direct write printing.

Refer now to FIG. 5B, which is a system schematic 508 of the aerosolized ink printer of FIG. 5A with the converging nozzle 506 removed. Again, the XY table 510 translates relative to the integrated sheath coupling shroud 504 to allow for direct write printing onto a substrate (not shown here).

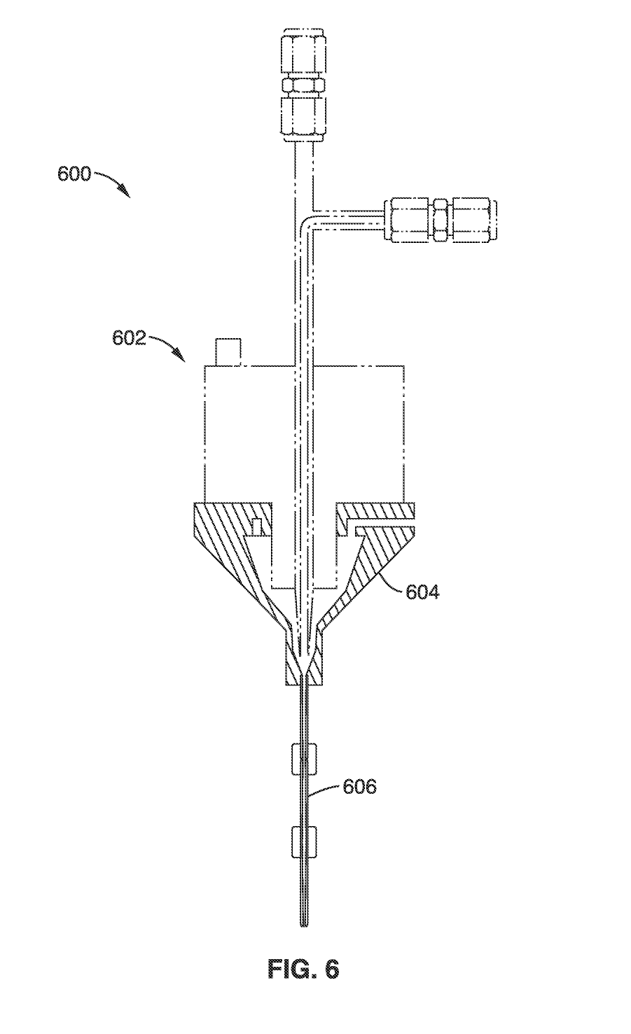

Refer now to FIG. 6, which is a partial cross sectional view 600 of a prior art ultrasonic source 602 flowing aerosolized ink through an integrated sheath coupling shroud 604 into a collimated-aerosol-beam nozzle 606 for direct write printing applications. FIG. 6 is similar to the device shown in FIG. 5A, but with the collimated-aerosol-beam nozzle 606 instead of the converging nozzle 506 of FIG. 5A.

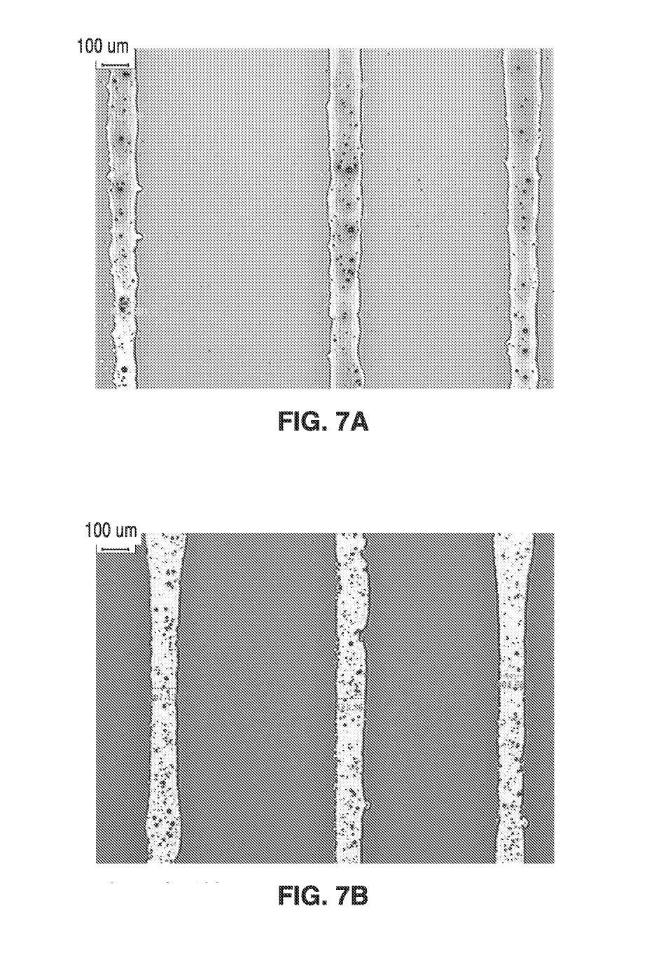

Refer now to FIG. 7A and FIG. 7B, which are micrographs of lines in different substrate locations that are direct printed with a 200 μm nozzle using Ag ink, resulting in a line width of approximately 100 μm. Here, it is apparent that the line widths produced are near 100 μm.

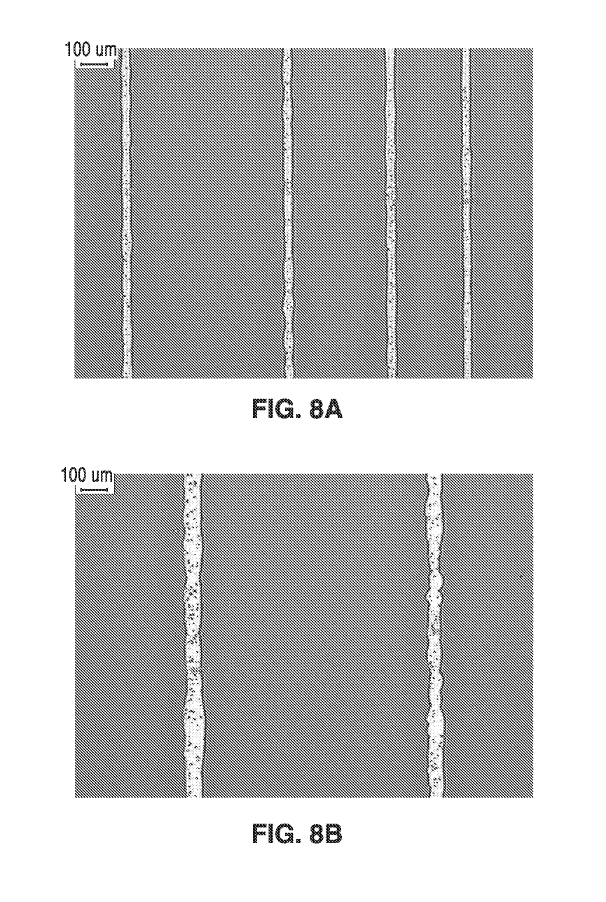

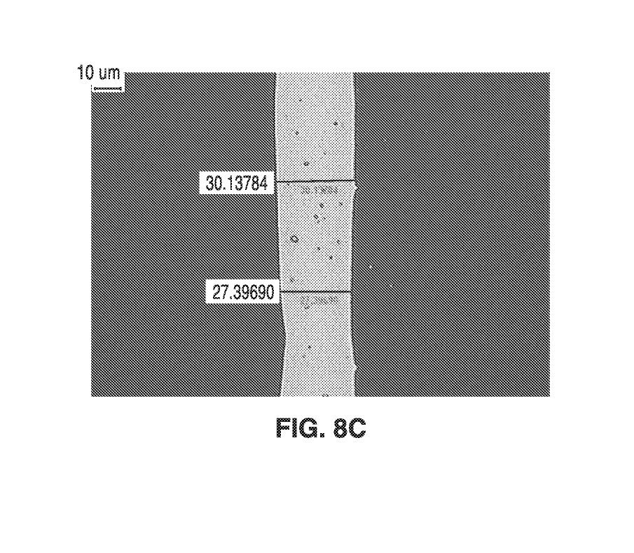

Refer now to FIG. 8A, which is a first micrograph of lines direct printed with a 100 μm collimated-aerosol-beam nozzle using Ag ink, resulting in a line width of approximately 40-60 μm.

Refer now to FIG. 8B, which is a second micrograph of a different region of direct printed with a 100 μm collimated-aerosol-beam nozzle using Ag ink, also resulting in a line width of approximately 40-60 μm.

However, now refer to FIG. 8C, which is a third micrograph of a different region of direct printed with a 100 μm collimated-aerosol-beam nozzle using Ag ink. Here, the resulting line width is approximately 30 μm.

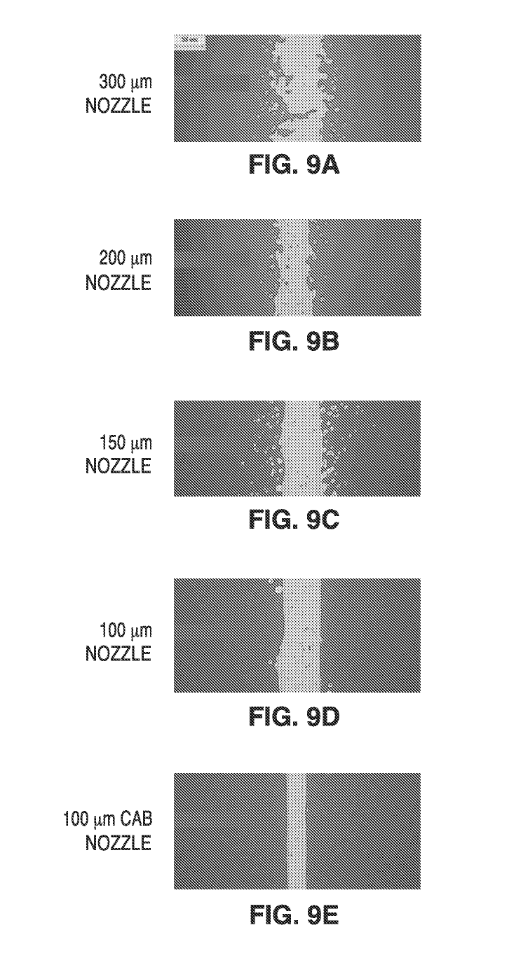

Refer now to FIG. 9A through FIG. 9D, which are micrographs of lines printed with a converging nozzle with 20 SCCM of N₂ carrier gas, 40 SCCM of N₂ sheath gas, 1 μL/min of ink supply, ˜2 mm standoff, 25 mm/s stage velocity, and a 60° C. stage temperature. FIG. 9A was produced with a 300 μm converging nozzle, FIG. 9B a 200 μm converging nozzle, FIG. 9C with a 150 μm converging nozzle, and FIG. 9D with a 100 μm converging nozzle.

Refer now to FIG. 9E, which is a micrograph of a line printed with a 100 μm collimated-aerosol-beam nozzle with 20 SCCM of N₂ carrier gas, 40 SCCM of N₂ sheath gas, 1 μL/min of ink supply, ˜2 mm standoff, 25 mm/s stage velocity, and 60° C. stage temperature.

Referring now to FIG. 9A through FIG. 9E, it is apparent that line quality improves as the nozzle diameter decreases. Finally, in FIG. 9E, the best quality line is produced with the 100 μm collimated-aerosol-beam nozzle.

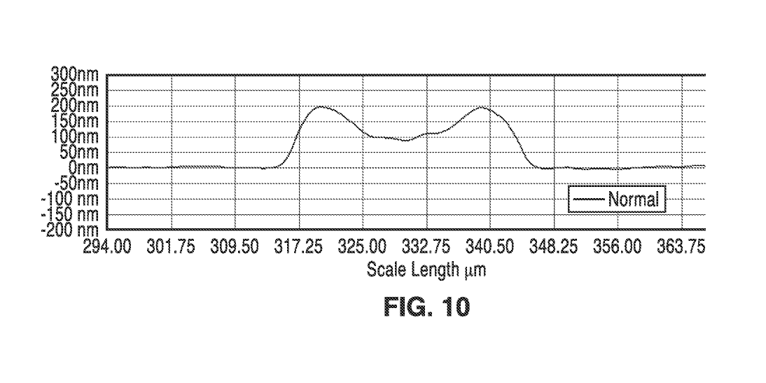

Refer now to FIG. 10, which is a graph of the height of a cross section of the trace of FIG. 9E, indicating that the edges of the printed line are thicker than the center, likely due to readily correctable ink surface tension effects. Such surface tension effects are correctable with changes in solvents or substrate temperatures.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

From the discussion above it will be appreciated that the invention can be embodied in various ways, including the following:

1. A method of direct write printing, comprising: (a) providing an ink to be printed; (b) aerosolizing the ink with an ultrasonic source into an aerosolized ink; and (c) direct write printing the aerosolized ink using steps comprising: (i) flowing the aerosolized ink from the ultrasonic source to a nozzle; and (ii) flowing the aerosolized ink from the nozzle onto a substrate.

2. The method of any preceding embodiment, wherein the flowing of the aerosolized ink from the ultrasonic source to the nozzle comprises: (a) passing a sheath gas around a terminus of the ultrasonic source, and then through the nozzle; (b) whereby the sheath gas entrains and transports the aerosolized ink.

3. The method of any preceding embodiment, wherein the nozzle is selected from a group of nozzles consisting of: a converging nozzle, and a convergent-divergent-convergent (CDC) nozzle.

4. The method of any preceding embodiment, wherein a carrier gas passes proximally to a terminus of the ultrasonic source.

5. The method of any preceding embodiment, wherein only the sheath gas transports the aerosolized ink through the nozzle, and then onto the substrate.

6. The method of any preceding embodiment, further comprising: (a) providing a coupling shroud disposed between the ultrasonic source and the nozzle, the coupling shroud comprising: (i) a through passage disposed between the terminus of the ultrasonic source and the nozzle; (ii) wherein the aerosolized ink is transported by the sheath gas from the terminus of the ultrasonic source to the nozzle; (iii) a sheath gas supply port; (iv) a sheath gas plenum fluidly connected to the sheath gas supply port; (v) wherein the sheath gas plenum is radially symmetrically disposed about the ultrasonic source terminus; and (vi) wherein the nozzle is attached to the coupling shroud.

7. The method of any preceding embodiment, comprising: (a) injecting the ink into a center of the ultrasonic source; (b) flowing the carrier gas axisymmetrically about the terminus of the ultrasonic source.

8. The method of any preceding embodiment wherein the ink comprises a suspension of nanoparticles in a liquid.

9. The method of any preceding embodiment wherein the ink comprises one or more polymers dissolved in a solvent.

10. The method of any preceding embodiment wherein the ink comprises one or more liquid silane components selected from a group of silanes consisting of: cyclopentasilane and cyclohexasilane.

11. The method of any preceding embodiment, wherein the ink further comprises one or more components selected from a group of components consisting of: a mixture of liquid silanes, a solvent, and a polyhydrosilane.

12. The method of any preceding embodiment, wherein a flow rate of the aerosolized ink is controlled by either: (a) a flow rate of the ink, or (b) a power supply level of the ultrasonic source.

13. The method of any preceding embodiment, wherein a shutter is used to control the direct write printing of the aerosolized ink to turn on or off printing to the substrate.

14. The method of any preceding embodiment, wherein a control of a supply of the ink is used to turn on or off printing of the direct write printing of the aerosolized ink onto the substrate.

15. The method of any preceding embodiment, wherein the nozzle is convergent-divergent-convergent.

16. A convergent-divergent-convergent direct write printer, comprising: (a) an ultrasonic source; (b) a convergent-divergent-convergent nozzle; (c) a coupling shroud disposed between the ultrasonic source and the convergent-divergent-convergent nozzle, the coupling shroud comprising: (i) an attachment to the ultrasonic source; (ii) an attachment to the convergent-divergent-convergent nozzle; (iii) a fluid passage between the ultrasonic source and the convergent-divergent-convergent nozzle; (iv) a sheath gas source annularly disposed about a terminus of the ultrasonic source; (v) wherein the sheath gas passes around the terminus of the ultrasonic source, through the fluid passage, and out the convergent-divergent-convergent nozzle; (vi) wherein ink introduced into the ultrasonic source is aerosolized and entrained by the sheath gas; (vii) whereby the sheath gas entrained aerosolized ink exits the convergent-divergent-convergent nozzle and is printed on a substrate.

17. The printer of any preceding embodiment, wherein the ultrasonic source further comprises a carrier gas source proximal to the terminus of the ultrasonic source.

18. The printer of any preceding embodiment, wherein the ultrasonic source further comprises an ultrasonic power supply whereby the ink is aerosolized when the ultrasonic power supply is active.

19. The printer of any preceding embodiment, wherein the ultrasonic source further comprises a flow-rate controllable ink supply whereby the ink is aerosolized when the ink is supplied to the ultrasonic source.

20. The printer of any preceding embodiment, wherein the convergent-divergent-convergent nozzle comprises: (a) a final output port; and (b) means for spraying aerosolized ink through the final output port in a combined flow, said combined flow comprising: (i) the aerosolized ink; (ii) the sheath gas in a laminar sheath gas flow; and (iii) the carrier gas in a laminar carrier gas flow; (iv) wherein the laminar carrier gas carries the aerosolized ink in an aerosolized laminar particle stream within the laminar sheath gas flow; (c) wherein the means for spraying particles through the final output port further comprises: (i) a first nozzle having an input port, an output port, and a length, said first nozzle having a taper along its length, said output port of said first nozzle having a diameter smaller than its input port; (ii) a second nozzle in series with said first nozzle, said second nozzle having an input port, an output port, and a length, said input port contiguous with said output port of said first nozzle, said second nozzle having a taper along its length, said output port of said second nozzle having a diameter larger than its input port; and (iii) a third nozzle in series with said second nozzle, said third nozzle having an input port, said final output port, and a length, said input port contiguous with said output port of said second nozzle, said third nozzle having a taper along its length, said final output port of said third nozzle having a diameter smaller than its input port; (d) wherein each nozzle has a length of approximately 9 mm to approximately 20 mm; and (e) wherein: (i) the diameter of the output port of the first nozzle is approximately 50 μm to approximately 200 μm; (ii) the diameter of the input port of the second nozzle is approximately 50 μm to approximately 200 μm; and (iii) the diameter of the final output port of the third nozzle is approximately 50 μm to approximately 200 μm.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of direct write printing, comprising:
(a) providing an ink to be printed;
(b) aerosolizing the ink with an ultrasonic source into an aerosolized ink; and
(c) direct write printing the aerosolized ink using steps comprising:
(i) flowing the aerosolized ink from the ultrasonic source to a nozzle; and
(ii) flowing the aerosolized ink from the nozzle onto a substrate.

2. The method of claim 1, wherein the flowing of the aerosolized ink from the ultrasonic source to the nozzle comprises:
(a) passing a sheath gas around a terminus of the ultrasonic source, and then through the nozzle;
(b) whereby the sheath gas entrains and transports the aerosolized ink.

3. The method of claim 1, wherein the nozzle is selected from a group of nozzles consisting of: a converging nozzle, and a convergent-divergent-convergent (CDC) nozzle.

4. The method of claim 1, wherein a carrier gas passes proximally to a terminus of the ultrasonic source.

5. The method of claim 2, wherein only the sheath gas transports the aerosolized ink through the nozzle, and then onto the substrate.

6. The method of claim 2, further comprising:
(a) providing a coupling shroud disposed between the ultrasonic source and the nozzle;
(b) wherein the coupling shroud comprises:
(i) a through passage disposed between the terminus of the ultrasonic source and the nozzle;
(ii) wherein the aerosolized ink is transported by the sheath gas from the terminus of the ultrasonic source to the nozzle;
(iii) a sheath gas supply port; and
(iv) a sheath gas plenum fluidly connected to the sheath gas supply port;
(v) wherein the sheath gas plenum is radially symmetrically disposed about the ultrasonic source terminus; and
(vi) wherein the nozzle is attached to the coupling shroud.

7. The method of claim 4, further comprising:
(a) injecting the ink into a center of the ultrasonic source; and
(b) flowing the carrier gas axisymmetrically about the terminus of the ultrasonic source.

8. The method of claim 1, wherein the ink comprises a suspension of nanoparticles in a liquid.

9. The method of claim 1, wherein the ink comprises one or more polymers dissolved in a solvent.

10. The method of claim 1, wherein the ink comprises one or more liquid silane components selected from a group of silanes consisting of: cyclopentasilane and cyclohexasilane.

11. The method of claim 10, wherein the ink further comprises one or more components selected from a group of components consisting of: a mixture of liquid silanes, a solvent, and a polyhydrosilane.

12. The method of claim 1, wherein a flow rate of the aerosolized ink is controlled by either:
(a) a flow rate of the ink, or
(b) a power supply level of the ultrasonic source.

13. The method of claim 1, wherein a shutter is used to control the direct write printing of the aerosolized ink to turn on or off printing to the substrate.

14. The method of claim 1, wherein a control of a supply of the ink is used to turn on or off printing of the direct write printing of the aerosolized ink onto the substrate.

15. The method of claim 1, wherein the nozzle is convergent-divergent-convergent.

16. A convergent-divergent-convergent direct write printer, comprising:
(a) an ultrasonic source;
(b) a convergent-divergent-convergent nozzle; and
(c) a coupling shroud disposed between the ultrasonic source and the convergent-divergent-convergent nozzle;
(d) wherein the coupling shroud comprises:
(i) an attachment to the ultrasonic source;
(ii) an attachment to the convergent-divergent-convergent nozzle;
(iii) a fluid passage between the ultrasonic source and the convergent-divergent-convergent nozzle; and
(iv) a sheath gas source annularly disposed about a terminus of the ultrasonic source;
(v) wherein the sheath gas passes around the terminus of the ultrasonic source, through the fluid passage, and out the convergent-divergent-convergent nozzle;
(vi) wherein ink introduced into the ultrasonic source is aerosolized and entrained by the sheath gas; and
(vii) whereby the sheath gas entrained aerosolized ink exits the convergent-divergent-convergent nozzle and is printed on a substrate.

17. The printer of claim 16, wherein the ultrasonic source further comprises a carrier gas source proximal to the terminus of the ultrasonic source.

18. The printer of claim 16, wherein the ultrasonic source further comprises an ultrasonic power supply whereby the ink is aerosolized when the ultrasonic power supply is active.

19. The printer of claim 16, wherein the ultrasonic source further comprises a flow-rate controllable ink supply whereby the ink is aerosolized when the ink is supplied to the ultrasonic source.

20. The printer of claim 17, wherein the convergent-divergent-convergent nozzle comprises:
(a) a final output port; and
(b) means for spraying aerosolized ink through the final output port in a combined flow;
(c) wherein said combined flow comprises
(i) the aerosolized ink;
(ii) the sheath gas in a laminar sheath gas flow; and
(iii) the carrier gas in a laminar carrier gas flow;
(iv) wherein the laminar carrier gas carries the aerosolized ink in an aerosolized laminar particle stream within the laminar sheath gas flow;
(d) wherein the means for spraying particles through the final output port comprises:
(i) a first nozzle having an input port, an output port, and a length, said first nozzle having a taper along its length, said output port of said first nozzle having a diameter smaller than its input port;
(ii) a second nozzle in series with said first nozzle, said second nozzle having an input port, an output port, and a length, said input port contiguous with said output port of said first nozzle, said second nozzle having a taper along its length, said output port of said second nozzle having a diameter larger than its input port; and
(iii) a third nozzle in series with said second nozzle, said third nozzle having an input port, said final output port, and a length, said input port contiguous with said output port of said second nozzle, said third nozzle having a taper along its length, said final output port of said third nozzle having a diameter smaller than its input port;
(e) wherein each nozzle has a length of approximately 9 mm to approximately 20 mm;
(f) wherein the diameter of the output port of the first nozzle is approximately 50 μm to approximately 200 μm;
(g) wherein the diameter of the input port of the second nozzle is approximately 50 μm to approximately 200 μm; and
(h) wherein the diameter of the final output port of the third nozzle is approximately 50 μm to approximately 200 μm.
